(19) United States
(12) Patent Application Publication
(10) Pub. No.: US 2014/0047097 A1
(43) Pub. Date: Feb. 13, 2014

(54) Probabilistic Inventory System

(71) Applicants: Eric Buehl, Studio City, CA (US); Matthew Austin Meredith, Marina Del Rey, CA (US)

(72) Inventors: Eric Buehl, Studio City, CA (US); Matthew Austin Meredith, Marina Del Rey, CA (US)

(73) Assignee: HULU LLC, Los Angeles, CA (US)

(21) Appl. No.: 13/569,662

(22) Filed: Aug. 8, 2012

(51) Int. Cl. G06F 15/173

(52) U.S. Cl. 709/224

(57) ABSTRACT

A method stores entries including user activity information for users using computing devices and unique identifiers for computing devices as inventory information for the users. For an entry, a unique identifier for a computing device is determined based on network activity for the computing device being connected to a network and user activity information for the network activity includes user identification information determined from the computing device while the computing device is connected to the network. The method then determines multiple entries for the user including user identification information and a set of unique identifiers for a set of computing devices. The multiple entries for the user are compared against criteria to determine if the user should be assigned to a computing device based on the user activity of the user. The user is assigned to the computing device using the unique identifier if the comparison meets a threshold.

### BACKGROUND

An organization may want to track which users are using which computing devices. For example, an information technology (IT) department may compile an inventory of computing devices to know where computing devices are at a given time, such as a user A has computing device #1. To compile the inventory, an administrator may walk around and manually scan computing devices that are found in the office space. Once scanned, the administrator assigns the computing device to a user. The scanning process is a highly manual process. Also, the scanning process is further complicated because users may have many different computing devices, such as tablet devices, smartphones, laptops, desktop computers, etc. These computing devices may be constantly moved by a user and scanning of some computing devices may be missed by the administrator.

Also, users may change which devices they use. For example, users may continually change which smartphone they are using. When this occurs, the user should be assigned to the new smartphone. In this case, the administrator scans the new smartphone and assigns the new smartphone to the user. The user also should be unassigned from the old smartphone if the user is not using the old smartphone anymore. However, an administrator may not automatically know to disassociate the user with the old smartphone unless the user notifies the administrator or the administrator asks the user if the new smartphone is replacing the old smartphone. Thus, the current view of the inventory may not be accurate.

### SUMMARY

In one embodiment, a method stores entries including user activity information for a plurality of users using a plurality of computing devices and a plurality of unique identifiers for the plurality of computing devices as inventory information for the plurality of users. For an entry, a unique identifier for a computing device is determined based on network activity for the computing device being connected to a network and user activity information for the network activity includes user identification information determined from the computing device while the computing device is connected to the network. The method then determines multiple entries for the user where the multiple entries include user identification information and a set of unique identifiers for a set of computing devices. The multiple entries for the user are compared against criteria to determine if the user should be assigned to a computing device in the set of computing devices based on the user activity of the user on the computing device. The user is assigned to the computing device using the unique identifier for the computing device if the comparison meets a threshold.

In one embodiment, a non-transitory computer-readable storage medium is provided containing instructions, that when executed, control a computer system to be configured for: storing entries including user activity information for a plurality of users using a plurality of computing devices and a plurality of unique identifiers for the plurality of computing devices as inventory information for the plurality of users, wherein, for an entry, a unique identifier for a computing device is determined based on network activity for the computing device being connected to a network and user activity information for the network activity includes user identification information determined from the computing device while the computing device is connected to the network; determining multiple entries for the user, the multiple entries including user identification information and a set of unique identifiers for a set of computing devices; comparing the multiple entries for the user against criteria to determine if the user should be assigned to a computing device in the set of computing devices based on the user activity of the user on the computing device; and assigning the user to the computing device using the unique identifier for the computing device if the comparison meets a threshold.

In one embodiment, an apparatus is provided comprising: one or more computer processors; and a computer-readable storage medium comprising instructions, that when executed, control the one or more computer processors to be configured for: storing entries including user activity information for a plurality of users using a plurality of computing devices and a plurality of unique identifiers for the plurality of computing devices as inventory information for the plurality of users, wherein, for an entry, a unique identifier for a computing device is determined based on network activity for the computing device being connected to a network and user activity information for the network activity includes user identification information determined from the computing device while the computing device is connected to the network; determining multiple entries for the user, the multiple entries including user identification information and a set of unique identifiers for a set of computing devices; comparing the multiple entries for the user against criteria to determine if the user should be assigned to a computing device in the set of computing devices based on the user activity of the user on the computing device; and assigning the user to the computing device using the unique identifier for the computing device if the comparison meets a threshold.

The following detailed description and accompanying drawings provide a better understanding of the nature and advantages of particular embodiments.

### BRIEF DESCRIPTION OF THE DRAWINGS

FIG. 1 depicts a simplified system for performing inventory control according to one embodiment.

FIG. 2 depicts a more detailed example of the system according to one embodiment.

FIG. 3 depicts a simplified flowchart of a method for assigning computing devices to users according to one embodiment.

FIG. 4 depicts a simplified flowchart of a method for unassigning users according to one embodiment.

FIG. 5 depicts an example of an inventory manager according to one embodiment.

### DETAILED DESCRIPTION

Described herein are techniques for an inventory control system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

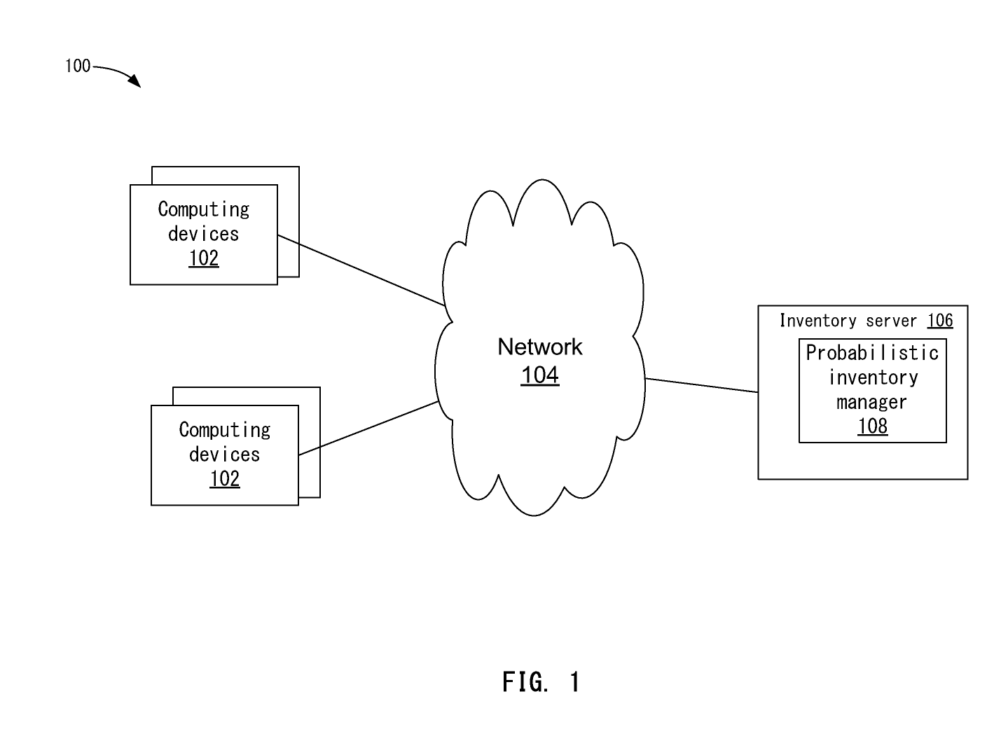

FIG. 1 depicts a simplified system 100 for performing inventory control according to one embodiment. System 100 includes a plurality of computing devices 102, a network 104, and an inventory server 106. Computing devices 102 may include tablet devices, smartphones, laptop computers, desktop computers, or other different types of computing devices. Computing devices 102 may also be used by different users. Also, any number of users may use any number of different computing devices 102. Although computing devices 102 are described, other inventory pieces may be tracked along with computing devices 102. Also, although one inventory server 106 is shown, multiple servers may be used.

Computing devices 102 may be associated with an entity, such as a company or an enterprise. For example, the entity may own and issue computing devices 102 to users that are employees of the entity. The entity may also not own computing devices 102. For example, users may bring their own computing device 102, such as a user may bring a smartphone that the user purchased him/herself and connects to network 104.

Network 104 may be a network associated with the enterprise. For example, network 104 is a local area network (LAN). Other networks may also connect to network 104. For example, users may connect to network 104 through a wide area network (WAN). In this case, a user may be logging into network 104 through the Internet. Network devices, such as routers, switches, etc., are included in network 104, but are not shown.

Inventory server 106 is coupled to network 104 and used to control inventory. For example, an inventory manager 108 automatically determines which computing devices 102 are associated with which users. The analysis is performed by probabilistically determining when a user should be assigned to computing device 102 based on an analysis of events that occur. For example, inventory manager 108 probabilistically determines the assignment by correlating user activity on a computing device 102 to network activity. As will be described below in more detail, one example may be assigning a user to a laptop computer when inventory manager 108 detects that the user has logged onto the company intranet multiple times in a month using a laptop that is identified via the network. Additionally, the analysis is used to unassign users from computing devices 102. For example, after a user is assigned to a computing device 102, inventory manager 108 may determine that that user is no longer using that computing device 102 and unassign the user from computing device 102. This process will be described in more detail below.

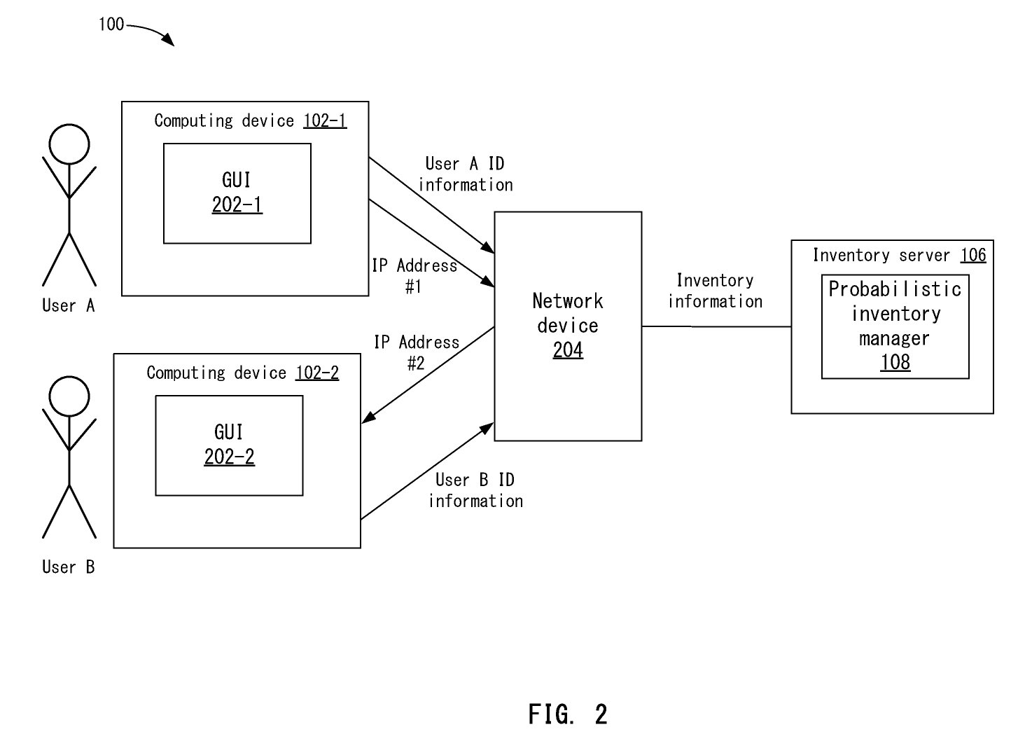

FIG. 2 depicts a more detailed example of system 100 according to one embodiment. System 100 determines network activity and can use the network activity to identify a computing device 102. In one example, a user A may be using computing device 102-1 and a user B may be using computing device 102-2. System 100 may identify both computing device 102-1 and 102-2 via different methods. For example, each computing device 102 may include a globally unique identifier (ID). In one embodiment, the globally unique ID may be a media access control (MAC) address. Other addresses that are globally unique may also be determined. When globally unique is described, the uniqueness may be globally unique among a subset of devices, such as a laptop computer may have a globally unique ID among laptop computers. Additionally, globally unique may be where substantially no other computing device 102 has the same globally unique identifier.

Globally unique ID 202 is statically configured for each computing device 102. For example, when computing device 102 is manufactured, globally unique ID 202 is assigned to computing device 102. Once, assigned, globally unique ID 202 does not change throughout the lifecycle of computing device 102.

System 100 also determines user activity based on a user using computing devices 102 while connected to network 104. For example, the user activity may be what type of activity a user is performing, such as logging in to an application or an intranet. Also, the user activity can identify a user. For example, when computing device 102-1 connects to network 104, a user (or computing device 102) provides user identification information to network 104. The user identification information may identify the user and may be in different forms. For example, a user may log in to an application on network 104 by providing credentials, such as a username and password. The credentials may be verified and uniquely identify the user to network 104 (or e.g. a network device in network 104). Other user identification information includes a user providing a name (e.g., “Robert”), but not a password. As will be described below, the different user activity information is used in probabilistically assigning a user to a computing device 102. For example, it is more likely that user A is using computing device 102-1 if a username and password are provided instead of just the name because a username and password may more likely be only known to user A while just inputting a name without a password may be input by anyone.

Once system 100 determines user identification information, the computing device being used needs to be identified. As described above, globally unique IDs 202 uniquely identify computing devices 102. However, inventory manager 108 may not be able to determine globally unique ID 202 directly from a computing device 102 connecting to network 108. Rather, a mapping may be needed. For example, a network device 204 can access a list of network addresses (e.g., IP addresses) that have been assigned to computing devices 102. Network device 204 can then map the IP address to a globally unique ID 202. For example, address resolution protocol (ARP) is used to map IP addresses to MAC addresses.

In one example, when computing device 102-1 connects to network 104, IP address #1 is assigned to computing device 102-1, and when computing device 102-2 connects to network 104, an IP address #2 is assigned to computing device 102-2. In one embodiment, the IP address that is assigned to computing device 102 is temporary. For example, when a user disconnects from network 104, and connects at a later time, another IP address is assigned to computing device 102. In other embodiments, static IP addressing may be used where the same IP address is assigned to computing device 102 every time computing device 102 connects to network 104. However, there is no guarantee that the assigned IP address is globally unique.

At this point, network device 204 now knows the user activity information including the identification information that was provided when connecting to network 104, the IP address assigned to computing device 102, and the globally unique ID 202 of computing device 102. Network device 204 can send that information to inventory server 106. For example, network device 204 sends a first message including “User A identification information, IP address #1, GUI #1” and a second message including “User B identification information, IP address #2, GUI #2” to inventory server 106. The message may also indicate the type of user activity or network activity, such as a log in to the intranet or a log in with credentials to an internal application. The above process may be performed to correlate multiple users to computing devices based on user activity and network activity.

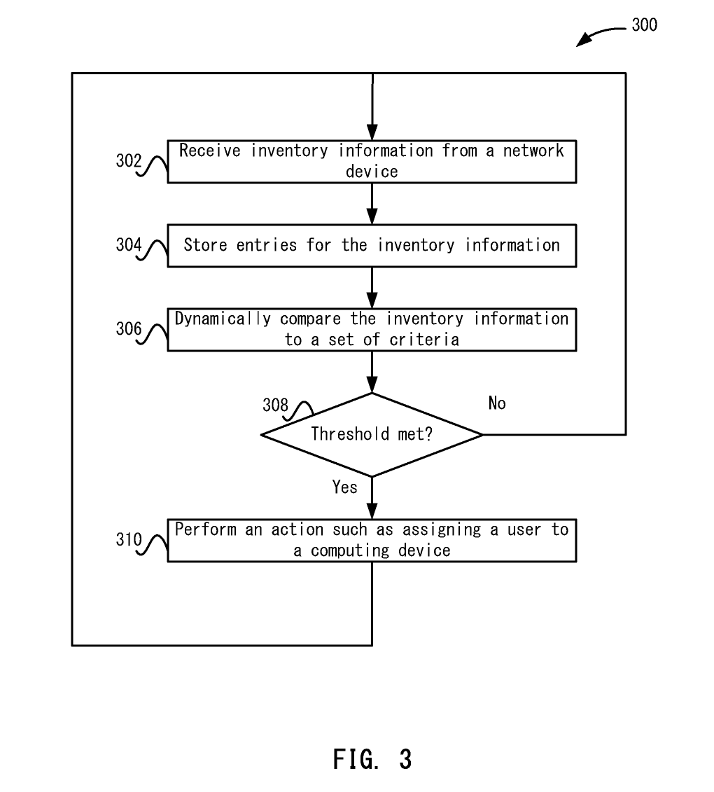

Inventory server 106 can dynamically use the inventory information included in the messages to assign and unassign computing devices 102 to and from users. FIG. 3 depicts a simplified flowchart 300 of a method for assigning computing devices 102 to users according to one embodiment. At 302, inventory manager 108 receives inventory information from network device 204. For example, the inventory information may include user identification information, an IP address, and a globally unique ID 202 for multiple users. Other user activity and network activity information may also be received, such as a time of connection to network 104, what kind of log in, what application was logged into, etc.

At 304, inventory manager 108 stores entries for the inventory information. For example, each time a user connects to network 104, a new entry is created with the inventory information. The entries may be stored via different keys, such as by globally unique ID 202, IP address, or user identification information.

At 306, inventory manager 108 dynamically compares the inventory information to a set of criteria. The comparison to criteria is used to probabilistically determine if a user is actually using computing device 102. The comparison analyzes the user activity and network activity. Some criteria may include the frequency or timeliness of connections and/or the type of user identification information received. For example, if a user logs into network 104 using computing device 102-1 every day for a month straight using a username and password for user A, then it is highly probable that computing device 102-1 is being used by user A. However, if a user provides just a name and connects to network 104 once a week for a month, the probability is less that computing device 102-1 belongs to user A. For example, because only a name has been provided and not a password, it is not certain that the person using computing device 102-1 is actually user A, such as a user may use “Robert”, but there may be multiple Robert's in the company and also the name has not been verified with a password. Also, if the frequency of use is less, it is possible the user is only using a friend's computing every once in a while. In another example, a user may not log in using credentials but may be logging in from a port that is associated with a desk used by the user. This may be considered a lower probability because credentials are not being input. However, the location of the desk may be used to identify the user, which increases the probability the user is using computing device 102.

At 308, inventory manager 108 determines if the comparison meets a threshold. For example, to assign a user to a computing device 102, the probability must reach a certain level, such as a user may have to be detected as using a computing device 102 more than ten times over a month period. Although a threshold is described, other methods may be used. For example, particular embodiments may use a rating system. Different activity is rated and when a rating is achieved, a user is assigned to a computing device 102.

If the threshold is met, at 310, inventory manager 108 performs an action. For example, inventory manager 108 may assign user A to computing device 102-1. When assigning a user to a computing device 102, a mapping from globally unique ID 202 for computing device 102 to user A may be stored. Also, inventory manager 108 may send an alert indicating that user A is using computing device 102-1 to various departments of the entity. For example, a help desk would then know user A is using computing device 102-1 and can use that information if user A calls the help desk.

In one example, a user A uses a smartphone to connect to a network 104. The user continues to connect every day in the same area. Also, the user logs in using a user name/password that authenticates the user to network 104. For example, the user may log on to an intranet or an application on the LAN. The user is assigned an IP address that is similar because the user is logging in to the same area of network 104. After the user logs in every day for 10 days straight, inventory manager 108 makes a determination that the user should be assigned to the smartphone.

If the inventory information does not meet a threshold, then the process reiterates to 302 where the dynamic analysis continues. For example, the analysis of inventory information may be continuous and users may be assigned to computing devices 102 as inventory information is received. This is performed automatically without input from a user. Also, after 310, the process continues at 302 to continue the analysis.

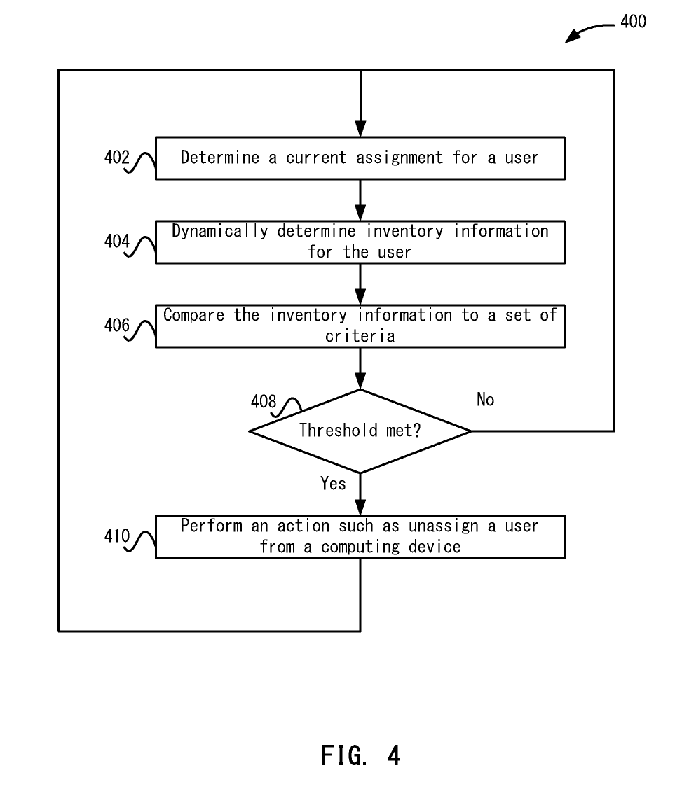

Inventory manager 108 may also dynamically unassign users from computing devices 102. Although this process is described separately from FIG. 3, the assigning and unassigning may be performed concurrently by analyzing inventory information. FIG. 4 depicts a simplified flowchart 400 of a method for unassigning users according to one embodiment. At 402, inventory manager 108 determines a current assignment for a user. For example, user A may be assigned to computing device 102-1.

At 404, inventory manager 108 dynamically determines inventory information for the user. For example, inventory information for that computing device 102-1 is retrieved. In some embodiments, inventory information for other computing devices 102 may also be retrieved. For example, it may be useful to analyze if a user is using another computing device 102 more frequently.

At 406, inventory manager 108 compares the inventory information to a set of criteria. The comparison to criteria is used to probabilistically determine if a user is not using computing device 102. For example, the probability a user is using computing device 102 may go down if a user logs in to network 104 with a username and password for user A using computing device 102-1 less frequently. In another example, a user may start logging in using another computing device 102-2 more frequently. This may cause the probability that the user is using computing device 102-1 to go down. For example, user A may stop using a first desktop computer and start using a second desktop computer more frequently and the login may be from the same desk. This may lower the probability that user A is using the first desktop computer because the user may most likely not use two desktop computers from the same location. However, if user A started using a smartphone, then this use may not affect the probability that user A is using the first desktop computer because use of both the smartphone and desktop computer is usually not mutually exclusive.

At 408, inventory manager 108 determines if the comparison meets a threshold. For example, to unassign a user from a computing device 102, the frequency of use must go below a certain level, such as a user may have to be detected as using a computing device 102 less than two times over a month period.

If the threshold is met, at 410, inventory manager 108 performs an action. For example, inventory manager 108 may unassign user A from computing device 102-1. Also, inventory manager 108 may send an alert indicating that user A has not used computing device 102-1 in 2 months. In this case, a help desk may want to ask user A what computing device 102 the user has been using. Also, the help desk may want to reclaim (i.e., have user A return) computing device 102-1 if user A is not using that computing device anymore.

If the threshold is not met, then the process reiterates to 402 where inventory entries for the user are continuously monitored. Also, after 410, the process continues at 402 to continue the analysis.

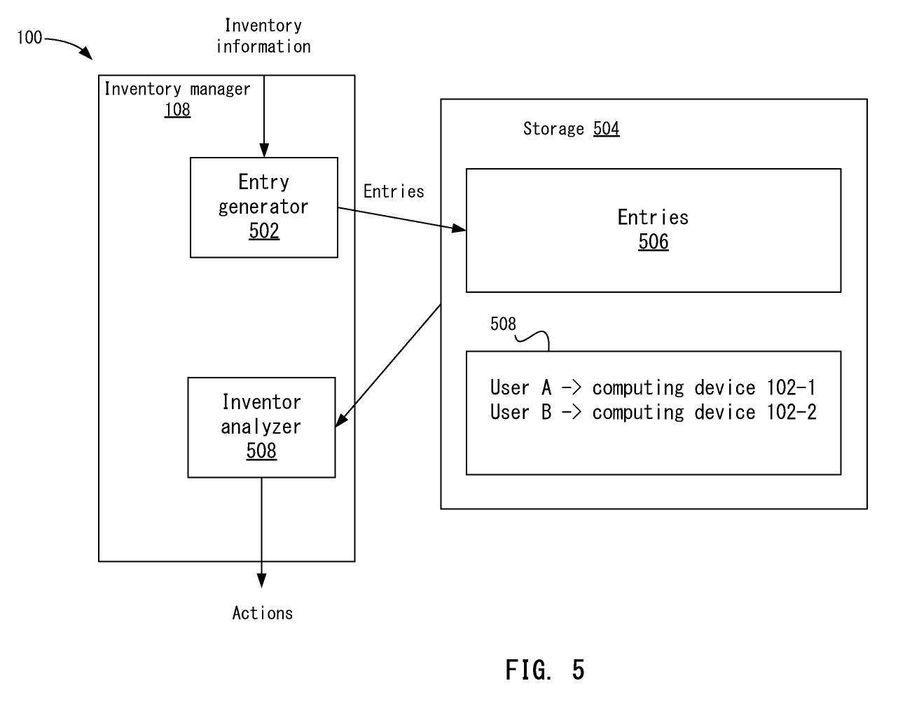

FIG. 5 depicts a more detailed example of inventory manager 108 according to one embodiment. Storage 504 stores inventory entries at 506. The inventory entries may be stored in different ways. For example, the entries may be stored based on multiple keys, such as by user identification information and/or globally unique ID 202. For each computing device 102, a history of use is provided. For example, each time a user logged in to network 104, an IP address/MAC address, and time are stored. Also, for each user, computing devices 102 have been assigned. For example, at 508, a user A has been assigned personal computer #1 and a user B has been assigned a laptop computer #1.

An entry generator 502 receives inventory information from network device 204. Entry generator 502 can then store entries in storage 504. For example, entry generator 502 can format the inventory information and store entries in different tables in storage 504. In one example, an entry is added for a table associated with user A when user A is detected as using a computing device 102.

An inventory analyzer 508 then determines actions to perform. For example, by analyzing the entries in storage 504, inventory analyzer 508 may assign or unassign computing devices 102 to users. Inventory analyzer 508 may also send alerts to different departments or perform other actions.

Accordingly, an automatic inventory system is provided that can analyze and assign computing devices 102 to users. Additionally, the inventory system may unassign users from computing devices 102. This process is performed passively and thus manual input is not needed from users to assign/unassign users to computing devices 102. The assignment process makes a probabilistic determination as to whether a user should be assigned/unassigned to/from a computing device 102. By using the probabilistic system, a user is assigned a computing device when a high probability that the user is using the computing device is determined. However, some errors may result due to the probabilistic nature of the system. These errors may not be fatal and may outweigh the time that would have to be taken to manually scan all computing devices.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
storing entries including user activity information for a plurality of users using a plurality of computing devices and a plurality of unique identifiers for the plurality of computing devices as inventory information for the plurality of users, wherein, for an entry, a unique identifier for a computing device is determined based on network activity for the computing device being connected to a network and user activity information for the network activity includes user identification information determined from the computing device while the computing device is connected to the network;
determining, by a computer system, multiple entries for the user, the multiple entries including user identification information and a set of unique identifiers for a set of computing devices;
comparing, by the computer system, the multiple entries for the user against criteria to determine if the user should be assigned to a computing device in the set of computing devices based on the user activity of the user on the computing device; and
assigning, by the computer system, the user to the computing device using the unique identifier for the computing device if the comparison meets a threshold.

2. The method of claim 1, wherein:
the threshold is based on a frequency, and
comparing comprises comparing a frequency of use of the computing device against the threshold.

3. The method of claim 1, wherein:
the threshold is based on a number of uses, and
comparing comprises comparing a number of uses of the computing device by the user against the threshold.

4. The method of claim 1, wherein the threshold comprises a first threshold, the method further comprising:
comparing newly received entries along with at least a portion of the multiple entries for the user against the set of criteria to determine if the assignment of the user to the computing device with the unique identifier should be removed; and
removing the assignment of the user to the computing device with the unique identifier if the comparison meets a second threshold for removing the assignment.

5. The method of claim 4, wherein:
the second threshold is based on a frequency of use or a number of uses, and
the removing is performed when use of the computing device by the user falls below the second threshold.

6. The method of claim 1, wherein the comparison analyzes different forms of the user activity information to determine if the user should be assigned to the computing device with the unique identifier.

7. The method of claim 1, further comprising:
determining a network address for the computing device based on network activity of the computing device being connected to the network; and
determining the unique identifier for the computing device using the network address, the unique identifier being statically assigned to the computing device.

8. The method of claim 7, wherein the unique identifier comprises a media access control (MAC) address and the network address comprises an Internet Protocol (IP) address.

9. The method of claim 1, further comprising determining the user identification information for the user based on the user activity.

10. The method of claim 9, wherein the user identification information is determined from receiving log in information for the user, the log in information identifying the user to the network.

11. A non-transitory computer-readable storage medium containing instructions, that when executed, control a computer system to be configured for:
storing entries including user activity information for a plurality of users using a plurality of computing devices and a plurality of unique identifiers for the plurality of computing devices as inventory information for the plurality of users, wherein, for an entry, a unique identifier for a computing device is determined based on network activity for the computing device being connected to a network and user activity information for the network activity includes user identification information determined from the computing device while the computing device is connected to the network;
determining multiple entries for the user, the multiple entries including user identification information and a set of unique identifiers for a set of computing devices;
comparing the multiple entries for the user against criteria to determine if the user should be assigned to a computing device in the set of computing devices based on the user activity of the user on the computing device; and
assigning the user to the computing device using the unique identifier for the computing device if the comparison meets a threshold.

12. The non-transitory computer-readable storage medium of claim 11, wherein:
the threshold is based on a frequency, and
comparing comprises comparing a frequency of use of the computing device against the threshold.

13. The non-transitory computer-readable storage medium of claim 11, wherein:
the threshold is based on a number of uses, and
comparing comprises comparing a number of uses of the computing device by the user against the threshold.

14. The non-transitory computer-readable storage medium of claim 11, wherein the threshold comprises a first threshold, further configured for:
comparing newly received entries along with at least a portion of the multiple entries for the user against the set of criteria to determine if the assignment of the user to the computing device with the unique identifier should be removed; and
removing the assignment of the user to the computing device with the unique identifier if the comparison meets a second threshold for removing the assignment.

15. The non-transitory computer-readable storage medium of claim 14, wherein:
the second threshold is based on a frequency of use or a number of uses, and
the removing is performed when use of the computing device by the user falls below the second threshold.

16. The non-transitory computer-readable storage medium of claim 11, wherein the comparison analyzes different forms of the user activity information to determine if the user should be assigned to the computing device with the unique identifier.

17. The non-transitory computer-readable storage medium of claim 11, further operable for:
determining a network address for the computing device based on network activity of the computing device being connected to the network; and
determining the unique identifier for the computing device using the network address, the unique identifier being statically assigned to the computing device.

18. The non-transitory computer-readable storage medium of claim 11, further configured for determining the user identification information for the user based on the user activity.

19. The non-transitory computer-readable storage medium of claim 18, wherein the user identification information is determined from receiving log in information for the user, the log in information identifying the user to the network.

20. An apparatus comprising:
one or more computer processors; and
a computer-readable storage medium comprising instructions, that when executed, control the one or more computer processors to be configured for:
storing entries including user activity information for a plurality of users using a plurality of computing devices and a plurality of unique identifiers for the plurality of computing devices as inventory information for the plurality of users, wherein, for an entry, a unique identifier for a computing device is determined based on network activity for the computing device being connected to a network and user activity information for the network activity includes user identification information determined from the computing device while the computing device is connected to the network;
determining multiple entries for the user, the multiple entries including user identification information and a set of unique identifiers for a set of computing devices;
comparing the multiple entries for the user against criteria to determine if the user should be assigned to a computing device in the set of computing devices based on the user activity of the user on the computing device; and
assigning the user to the computing device using the unique identifier for the computing device if the comparison meets a threshold.
